(19) United States
(12) Patent Application Publication
(10) Pub. No.: US 2010/0017874 A1
(43) Pub. Date: Jan. 21, 2010

(54) METHOD AND SYSTEM FOR LOCATION-AWARE AUTHORIZATION

(75) Inventors: Sandro Piccinini, Rome (IT); Luigi Pichetti, Rome (IT); Marco Secchi, Rome (IT); Francesco Termine, Palermo (IT)

Correspondence Address: IBM - EU c/o Myers Andras Sherman LLP, 19900 MacArthur Blvd., Suite 1150, Irvine, CA, 92612, US

(73) Assignee: International Business Machines Corporation, Armonk, NY (US)

(21) Appl. No.: 12/174,569

(22) Filed: Jul. 16, 2008

(51) Int. Cl. G06F 17/30

(52) U.S. Cl. 726/18

(57) ABSTRACT

A method and system for controlling access to a module based on spatial location of the module is provided. One implementation involves detecting spatial location of the module, accessing a set of rules indicating locations where access to the module is not authorized, and controlling access to the module based on the detected location by checking the detected location against the set of rules, and denying access to the module when the detected location is within locations where access to the module is not authorized.

### BACKGROUND OF THE INVENTION

1. Field of the Invention

The present invention relates generally to authorization systems and in particular to mobile device authorization.

2. Background Information

Consumer electronic devices such as personal computers, laptops, cell phones, and the like, are typically protected from unauthorized access based on a mix of user authentication mechanisms (e.g., using a defined user/password pair or digital fingerprint), and a local authorization control (e.g., a local LDAP registry, wherein the OS Registry can define, for each authenticated user, which application/data the user is authorized to use based on administrative privileges).

However, no restriction is in place based on the position of such devices to avoid, for example, a user accessing a device outside a specified building, city, region or country. For example, a company may decide to provide employees with a laptop but for privacy purposes the company may prefer to allow their use only in its buildings and/or the employee's home or city. Conventionally, this cannot be easily controlled without physically controlling the employee.

### SUMMARY OF THE INVENTION

The invention provides a method and system of controlling access to a module based on spatial location of the module. One embodiment involves detecting spatial location of the module, accessing a set of rules indicating locations where access to the module is not authorized, and controlling access to the module based on the detected location by checking the detected location against the set of rules, and denying access to the module when the detected location is within locations where access to the module is not authorized.

Detecting spatial location of the module may include detecting geographical location of the module based on a geographical positioning system. Said set of rules may be stored locally with the module, and accessing the set of rules includes local access to the rules. Said set of rules may be stored remotely from the module, and accessing the set of rules involves remotely accessing the set of rules.

Controlling access to the module may further include obtaining additional information for access authorization, checking the detected location against said set of rules, and authorizing access to the module based on the additional information and the detected location. The additional information includes user credentials, time and/or date information. The module may comprise an electronic device.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows a functional block diagram of a system implementing an embodiment of a location-aware access control, according to the invention.

FIG. 2 shows a functional block diagram of a system implementing another embodiment of a location-aware access control, according to an embodiment of the invention.

FIG. 3 shows a functional block diagram of an authentication subsystem, according to an embodiment of the invention.

FIG. 4 shows a flowchart of a location-aware access control process, according to an embodiment of the invention.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The invention provides a method and system for location-aware authorization such as for electronic devices (e.g., mobile electronic devices). One embodiment involves authorizing access to a standalone system such as a mobile device, by collecting user credentials on the device for authentication, obtaining location information (e.g., geographical position) for the device from a locating module such as a satellite navigation module attached to the device, accessing profile authorization information for authenticating the user based on the user credentials and device location information (localization), authorizing access to the device by the user if the profiled authorization settings match the credentials and the position of the device.

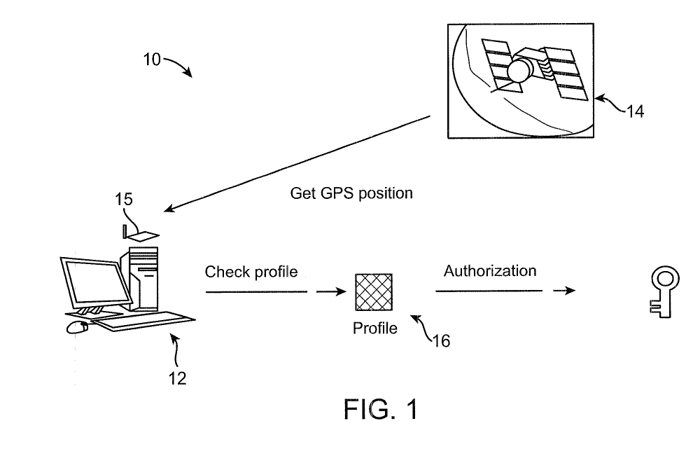

One implementation involves using a global position of a device in order to manage access to the device or applications/resources to be used by the device. FIG. 1 shows a functional block diagram of a system 10 implementing an embodiment of the invention. The system 10 leverages the global position of a device 12 and an instrumented configured setting to enable access to the device (i.e., running application on the device) for a specific user. Access to the system depends on the configured settings, whereby the system may e.g. determine not to start up at all if it is not located in a specific city, country or building, or may start with a limited functionality. The configured setting may inform the system to use a GPS card or simply an RFID posed on a server room, to guarantee that the server is in the required server room.

In one example, at device power on (e.g., at each boot or Operative System initialization), the global position of the device 12 is determined via a positioning system 14 (e.g., Global Positioning system (GPS)), using an embedded GPS module 15 in the device 12. Further, credentials of the user are obtained by the device 12 (e.g., via a user interface or from a file on the device). Then, a profile 16 associated with the user is obtained, wherein the profile include authentication settings. The user credentials and device position are checked against the profiled authentication setting 16 to determine if the user is authorized to access (use) the device 12. In one example, the profile authentication settings may be stored in system files, optionally encrypted and accessible only by an administrator. The profile authentication settings may include e.g. information about a locating mechanism (e.g., GPS, RFID), the level of location restriction (e.g., country, city, building, room), the level of restriction (e.g., start-up, applications, network connection, specific service and so on), and the user list associated with restriction.

An example operation involves a scenario where all positioning-sensitive authorization rules can be coded in a static profile (no exception needs to be handled). The static profile may include e.g. the rules to grant or deny authorization to disable managing any dynamic exception. In case the authorization system is a remote system, the system can dynamically manage the request and may e.g. determine to grant access in a specific timeframe, or grant access based on external factors (e.g., number of requests, daily policy or other generic factor that may change a static rule). In this example, such profile (e.g., profile 16 in FIG. 1) may be deployed in a protected area of the local device 12 itself, and is queried once the current GPS position is acquired, for each usage of resources (e.g., software applications, information) by a user utilizing the device 12 for implementing a positioning-aware authorization scheme according to the invention. The control can be either absolute or based on the logging user. In one embodiment this means that the control can be for a device or for a logged user that wants to access the device so that, for example, an Administrator can be granted and a DB2User not.

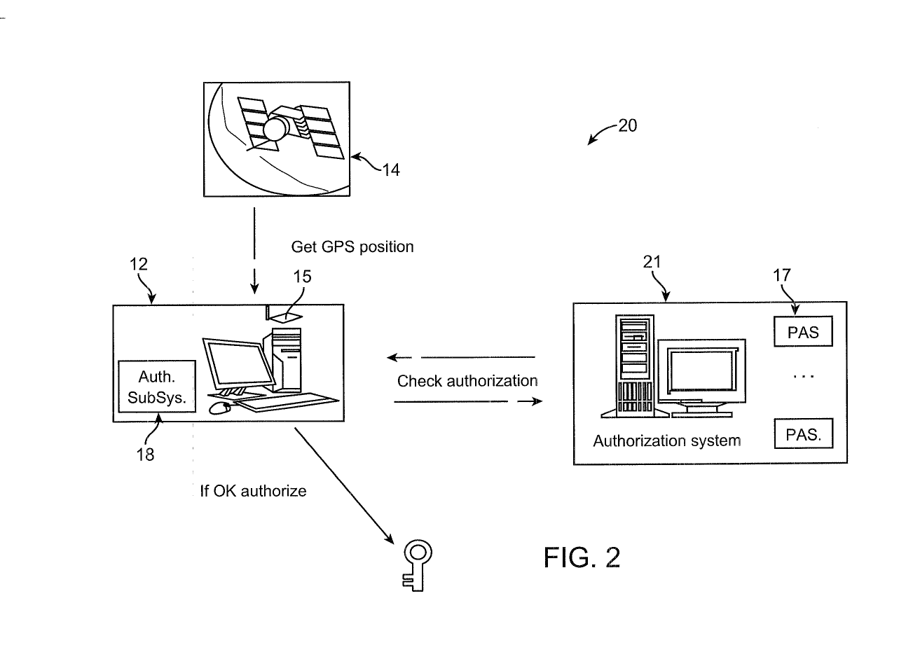

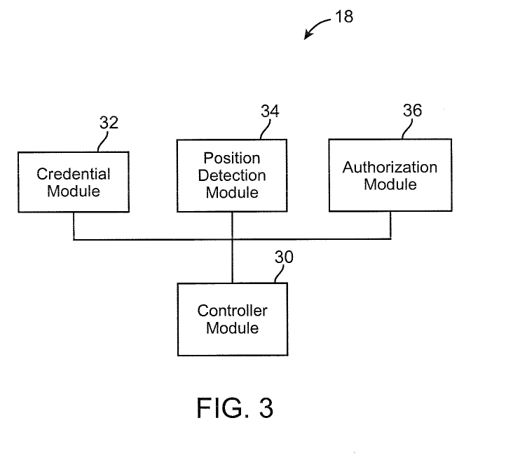

FIG. 2 shows another example system 20 according to the invention, wherein the controlled device includes an authorization subsystem 18. The subsystem 18 may be e.g., a software, hardware, or firmware component of the device 12. FIG. 3 shows an embodiment of the authorization subsystem 18, including a controller module 30, a credential module 32, a positioning module 34 and an authorization module 36. The controller 30 functions to control modules 32-36, such that at e.g., OS boot or OS resume time of device 12, the credential module 32 obtains user credentials and the position detection module 34 retrieves the current GPS position of the device 12 (this may be performed each time positioning-aware authorization is required). The authorization module then causes the detected position and user credentials to be wirelessly sent (e.g., via a General Packet Radio Service (GPRS) communication card embedded in module 15), to a remote authorization system 21.

The authorization system 21 matches the received device position and user credentials to a profiled authentication setting (PAS) 17 associated with the user (among multiple profiles). Authorization is provided if there is a proper match. The remote authorization system 21 informs the authorization module 36 of the authorization (authentication) results, according to which the authorization module 36 allows/denies use of the device 12 by the user.

Although in the above example access to the device 12 is subject to positioning-aware authorization process, such a process can be applied to certain resources of the device 12, wherein only access to particular resources (e.g., software applications, information, operations) require positioning-aware authorization before a user can access such resources on (or through) device 12. Further, as described further below, the authorization may not require user credentials and may be based on the device location (position). In that case, if the device is detected to be in certain locations, then access to the device may be authorized by any user of the device, so long as the device is located within said certain locations (e.g., access by any user is authorized if the device is on the company premises, but access is denied if the device is outside the company premises).

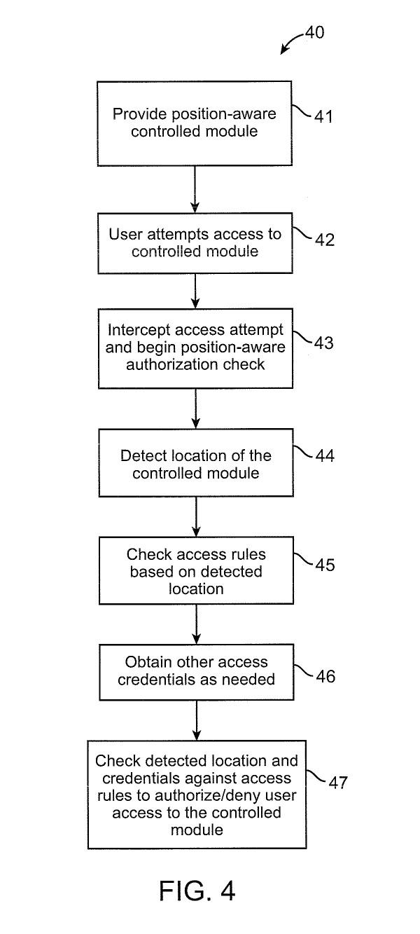

FIG. 4 shows an example positioning-aware authorization process 40 according to the invention, including:
Block 41: A module, such as a hardware device or a resource on the hardware device, is instrumented using a profile for controlling access to the module for use in certain positions/locations.
Block 42: A user attempts access to the controlled module.
Block 43: A position-aware authorization subsystem in the module intercepts the access attempt and invokes a position-aware authorization check.
Block 44: The authorization subsystem activates an embedded card in the hardware device (e.g., GPS receiver) to detect the spatial/geographical location of the device (i.e., detected location).
Block 45: The authorization subsystem looks up the detected location either in a local location authorization profile on the hardware device (e.g., profile 16 in FIG. 1) or interacts with a remote authorization system for checking a remote location authorization profile (e.g., profile 17 in FIG. 2), to check for rules of accessing the module (e.g., hardware device, operating system, software, data) in the detected location. The rules indicate the locations in which the device may not be authorized for access.
Block 46: If the authorization check is also based on other information such as user credentials, the authorization subsystem also asks for user credentials (e.g., identity, password).
Block 47: The authorization subsystem matches all needed information (e.g., detected device location, user credentials) to a said set of rules (in profile 16 or 17) to determine if access to the controlled module is authorized in the geographical location of the device. If access is authorized, the authorization subsystem allows access to the module (the authorization subsystem may periodically detect the location of the device such that if the device is moved outside certain authorized locations, then access to the controlled module is ceased/denied).

The position-aware access enforcement may be implemented in different manners, besides GPS. For example, position detection can be based on: cellular networks using a GPRS communication card, attributes from IP connectivity either wired or wireless, etc. Short range connectivity (e.g., Bluetooth) may be used, to ensure that a controlled module can only operate proximate a base station.

Communication for the remote authorization scenario (FIG. 2) may be implemented in different manners, besides GPRS. For example IP connectivity, if available, both wired or wireless can be leveraged for remote authorization.

The position-aware access enforcement functionality can be extended to also be based on time and/or date of access such that each controlled module can be authorized to work only on a specified location, by a specified user in a specified timeframe (e.g., day timeframe based on GPS position). Further, different resources on a device can have different user/date/time access requirements, at the same detected location.

The position-aware access enforcement functionality can be extended to cooperating modules such as software applications (e.g., client-server applications), such that the use of resources accessed by the cooperating module can be authorized based either on a server machine location and/or on a client machine location. For example, access to a server database may be authorized by a user in one country only when a user in another country is outside the normal working schedule, to avoid possible access conflicts.

As is known to those skilled in the art, the aforementioned example embodiments described above, according to the present invention, can be implemented in many ways, such as program instructions for execution by a processor, as software modules, as computer program product on computer readable media, as logic circuits, as silicon wafers, as integrated circuits, as application specific integrated circuits, as firmware, etc. Though the present invention has been described with reference to certain versions thereof; however, other versions are possible. Therefore, the spirit and scope of the appended claims should not be limited to the description of the preferred versions contained herein.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method of controlling access to a module based on spatial location of the module, comprising:
detecting spatial location of the module;
accessing a set of rules indicating locations where access to the module is not authorized; and
controlling access to the module based on the location by checking the detected location against the set of rules, and denying access to the module when the detected location is within locations where access to the module is not authorized.

2. The method of claim 1, wherein detecting spatial location of the module includes detecting geographical location of the module based on a geographical positioning system.

3. The method of claim 1, wherein said set of rules are stored locally with the module, and accessing the set of rules includes local access to the rules.

4. The method of claim 1, wherein the rules are stored remotely from the module, and accessing the set of rules involves remotely accessing the set of rules.

5. The method of claim 1, wherein controlling access to the module further includes:
obtaining additional information for access authorization;
checking the detected location against said set of rules; and
authorizing access to the module based on the additional information and the detected location.

6. The method of claim 5, wherein the additional information includes user credentials.

7. The method of claim 6, wherein the additional information includes time and/or date information.

8. The method of claim 6, wherein the module comprises an electronic device.

9. An apparatus for controlling access to a module based on spatial location of the module, comprising:
a location detector configured for detecting spatial location of the module; and
a controller configured for accessing a set of rules indicating locations where access to the module is not authorized, and controlling access to the module based on the detected location by checking the detected location against the set of rules, and denying access to the module when the detected location is within locations where access to the module is not authorized.

10. The apparatus of claim 9, wherein the location detector is further configured for detecting geographical location of the module based on a geographical positioning system.

11. The apparatus of claim 9, wherein said set of rules are stored locally with the module, and the controller is configured for accessing the set of rules includes local access to the rules.

12. The apparatus of claim 9, wherein the rules are stored remotely from the module, and the controller is configured for accessing the set of rules involves remotely accessing the set of rules.

13. The apparatus of claim 9, wherein the controller is further configured for obtaining additional information for access authorization, and checking the detected location against said set of rules for authorizing access to the module based on the additional information and the detected location.

14. The apparatus of claim 13, wherein the additional information includes user credentials.

15. The apparatus of claim 14, wherein the additional information includes time and/or date information.

16. The apparatus of claim 14, wherein the module comprises an electronic device.

17. An access control system, comprising:
a controlled module
an authenticator configured for controlling access to the controller module based on spatial location of the module, the authenticator comprising:
a location detector configured for detecting spatial location of the module; and
a controller configured for accessing a set of rules indicating locations where access to the module is not authorized, and controlling access to the module based on the detected location by checking the detected location against the set of rules, and denying access to the module when the detected location is within locations where access to the module is not authorized.

18. The system of claim 17, wherein said set of rules are stored locally with the module, and the controller is configured for accessing the set of rules includes local access to the rules.

19. The system of claim 17, wherein the rules are stored remotely from the module, and the controller is configured for accessing the set of rules involves remotely accessing the set of rules.

20. The system of claim 19, further including a remote authentication control configured for receiving location information from the authenticator, checking the location against a set of rules, and informing the authenticator if the location is in authorized locations or otherwise.
